(19) United States
(12) Patent Application Publication
(10) Pub. No.: US 2025/0376175 A1
(43) Pub. Date: Dec. 11, 2025

(54) PASSENGER EXPERIENCE OPTIMIZATION SYSTEM, PASSENGER EXPERIENCE OPTIMIZATION METHOD, PASSENGER EXPERIENCE OPTIMIZATION DEVICE

(71) Applicant: TOYOTA JIDOSHA KABUSHIKI KAISHA, Toyota-shi (JP)

(72) Inventor: Daisuke HASHIMOTO, Chofu-shi (JP)

(73) Assignee: TOYOTA JIDOSHA KABUSHIKI KAISHA, Toyota-shi (JP)

(21) Appl. No.: 19/186,810

(22) Filed: Apr. 23, 2025

(30) Foreign Application Priority Data
Jun. 7, 2024 (JP) 2024-092856

(51) Int. Cl. B60W 50/00; B60W 10/04; B60W 10/18; B60W 10/20

(52) U.S. Cl. CPC B60W 50/0098; B60W 10/04; B60W 10/18; B60W 10/20; B60W 2050/0028; B60W 2710/18; B60W 2710/20

(57) ABSTRACT

A passenger experience optimization system including a vehicle having a vehicle sensor and a server device has a passenger user interface for interacting with a passenger of the vehicle using a first machine learning model, and generates information regarding the passenger based on a result of interaction with the passenger, generates a second machine learning model based on the information regarding the passenger, generates input information to be input to the second machine learning model for the second machine learning model to predict an experience of the passenger based on a detection result of the vehicle sensor, and generates feedback in natural language to be provided to a driver of the vehicle for improving the experience of the passenger.

### FIELD

The present disclosure relates to a passenger experience optimization system, a passenger experience optimization method, and a passenger experience optimization device.

### BACKGROUND

PTL 1 (JP-A-2023-181870) describes a technology for evaluating a driving operation of a driver of a vehicle based on driving data of the vehicle and notifying the driver of evaluation results.

However, in the technology described in PTL 1, the passenger of the vehicle does not evaluate the driving operation of the driver of the vehicle. Specifically, the passenger does not provide feedback on the driving operation of the driver to the driver. Furthermore, since the characteristics of each passenger are different, the evaluation of the driving operation of the driver by the passenger is different for each passenger. In the technology described in PTL 1, there is a risk that the driver of the vehicle cannot provide the passenger with a suitable experience.

### SUMMARY

In light of the foregoing, the present disclosure aims to provide a passenger experience optimization system, a passenger experience optimization method, and a passenger experience optimization device which enable a vehicle driver to provide a passenger with a suitable experience.

(1) An aspect of the present disclosure provides a passenger experience optimization system including a vehicle including a vehicle sensor and a vehicle processor and a server device including a server device processor, wherein the vehicle includes a passenger user interface for interacting with at least one passenger of the vehicle using a first machine learning model, the server device processor is configured to: generate information regarding the at least one passenger based on a result of interaction with the at least one passenger, and generate a second machine learning model for each passenger based on the information regarding the at least one passenger, and the vehicle processor is configured to: generate input information to be input to the second machine learning model for the second machine learning model to predict an experience of the at least one passenger based on a detection result of the vehicle sensor, and generate feedback in natural language to be provided to a driver of the vehicle for improving the experience of the at least one passenger based on at least the experience of the at least one passenger predicted by the second machine learning model.

(2) In the passenger experience optimization system of the aspect (1), the vehicle may include a driver user interface for receiving information regarding the driver of the vehicle, and the vehicle processor may be configured to generate the feedback based on the experience of the at least one passenger and the information regarding the driver of the vehicle.

(3) In the passenger experience optimization system of the aspect (1) or (2), the server device processor may be configured to generate the second machine learning model for each passenger based on the information regarding the at least one passenger and the detection result of the vehicle sensor after the at least one passenger boards the vehicle and before the interaction with the at least one passenger is performed.

(4) In the passenger experience optimization system of any one of the aspects (1) to (3), the server device processor may be configured to: search for one or more base passenger models which match the at least one passenger from a model pool based on the information regarding the at least one passenger, and generate the second machine learning model using the base passenger models, and the model pool may include at least one pretrained machine learning model which corresponds to various types of passengers.

(5) In the passenger experience optimization system of any one of the aspects (1) to (4), the server device processor may be configured to generate the second machine learning model by executing fine-tuning of the base passenger models based on the information regarding the at least one passenger.

(6) In the passenger experience optimization system of any one of the aspects (1) to (5), the server device processor may be configured to: execute a passenger experience simulation under various conditions based on the information regarding the at least one passenger, generate a training data set including condition and simulated experience, and train the second machine learning model using the training data set.

(7) In the passenger experience optimization system of any one of the aspects (1) to (6), the various conditions may include a plurality of positions of the vehicle and a plurality of control parameters including steering, driving, and braking of the vehicle.

(8) An aspect of the present disclosure provides a passenger experience optimization method including: interacting with at least one passenger of a vehicle using a first machine learning model, generating information regarding the at least one passenger based on a result of interaction with the at least one passenger, generating a second machine learning model for each passenger based on the information regarding the at least one passenger, generating input information to be input to the second machine learning model for the second machine learning model to predict an experience of the at least one passenger based on a detection result of a vehicle sensor, and generating feedback in natural language to be provided to a driver of the vehicle for improving the experience of the at least one passenger based on at least the experience of the at least one passenger predicted by the second machine learning model.

(9) An aspect of the present disclosure provides a passenger experience optimization device provided in a vehicle including a vehicle sensor and a passenger user interface for interacting with at least one passenger of the vehicle using a first machine learning model, wherein the passenger experience optimization device includes a processor, information regarding the at least one passenger is generated based on a result of interaction with the at least one passenger, a second machine learning model is generated for each passenger based on the information regarding the at least one passenger, and the processor is configured to: generate input information to be input to the second machine learning model for the second machine learning model to predict an experience of the at least one passenger based on a detection result of the vehicle sensor, and generate feedback in natural language to be provided to a driver of the vehicle for improving the experience of the at least one passenger based on at least the experience of the at least one passenger predicted by the second machine learning model.

According to the present disclosure, the driver of the vehicle can provide the passenger with a suitable experience.

### BRIEF DESCRIPTION OF DRAWINGS

FIG. 1 is a view showing an example of a passenger experience optimization system 1 of a first embodiment.

FIG. 2 is a view showing an example of the flow of data, etc., in the passenger experience optimization system 1 shown in FIG. 1.

FIG. 3 is a view showing an example of the data structure of an experience of a passenger PA1 of a vehicle 12 predicted by an experience prediction unit 431 (prediction result of the experience of the passenger PA1 of the vehicle 12 output from the experience prediction unit 431).

FIG. 4 is a view showing an example of the data structure of input information generated by an input information generation unit 432 and input to the experience prediction unit 431 (second machine learning model for the passenger PA1 of the vehicle 12).

FIG. 5 is a view showing an example of a detailed configuration of a model generation unit 3B shown in FIG. 1 and FIG. 2.

FIG. 6 is a sequence diagram for explaining an example of a process executed by the passenger experience optimization system 1 of the first embodiment.

FIG. 7 is a sequence diagram for explaining the example of the process executed by the passenger experience optimization system 1 of the first embodiment.

FIG. 8 is a view showing an example of a detailed configuration of the model generation unit 3B of the passenger experience optimization system 1 of a second embodiment.

### DESCRIPTION OF EMBODIMENTS

The embodiments of a passenger experience optimization system, a passenger experience optimization method, and a passenger experience optimization device of the present disclosure will be described below with reference to the drawings.

### First Embodiment

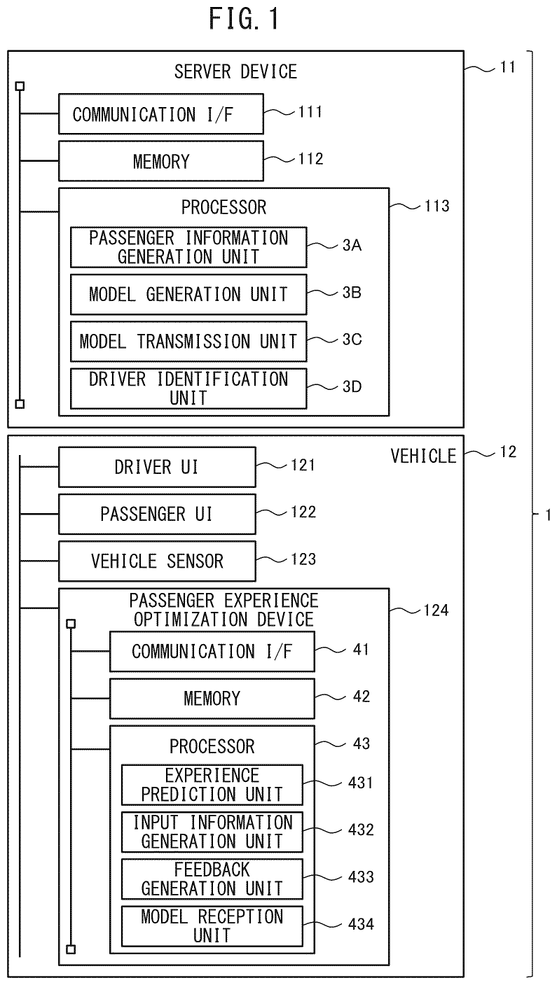

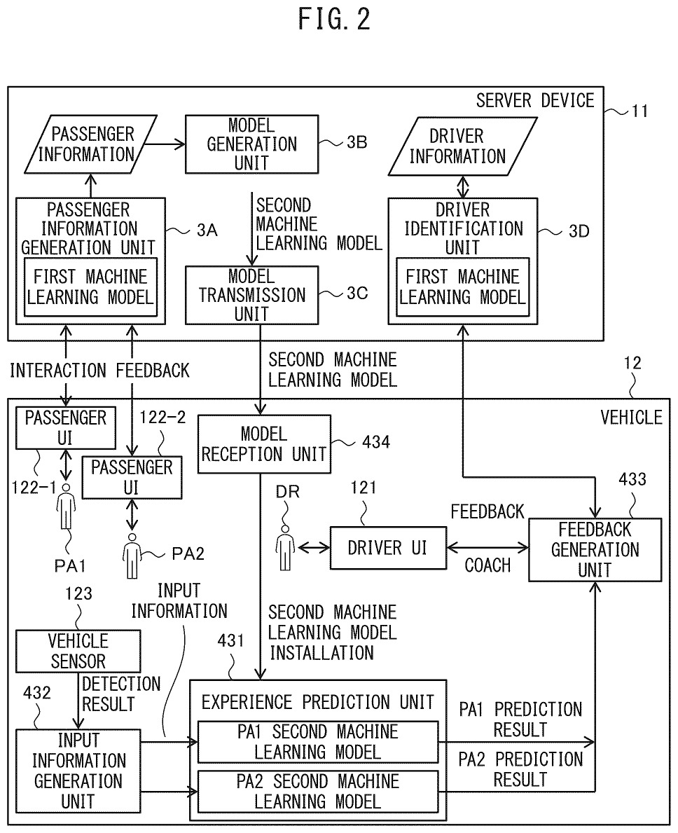

FIG. 1 is a view showing an example of a passenger experience optimization system 1 of a first embodiment. FIG. 2 is a view showing an example of the flow of data, etc., in the passenger experience optimization system 1 shown in FIG. 1.

In the example shown in FIG. 1 and FIG. 2, a server device 11 and a vehicle 12 are included in the passenger experience optimization system 1.

The vehicle 12 includes a driver user interface (UI) 121, a passenger user interface 122, a vehicle sensor 123, and the passenger experience optimization device 124.

The driver user interface 121 has a function of receiving information regarding a driver DR (refer to FIG. 2) of the vehicle 12 from the driver DR of the vehicle 12 using a first machine learning model and the like. The information regarding the driver of the vehicle 12 includes information indicating, for example, the driving skill, tendencies, characteristics, etc., of the driver DR of the vehicle 12. In another example, the vehicle 12 may not include the driver user interface 121.

In the example shown in FIG. 1 and FIG. 2, the passenger user interface 122 (122-1, 122-2) has a function of interacting with the passengers PA1, PA2 (refer to FIG. 2) of the vehicle 12 using the first machine learning model and the like. The passenger user interface 122 is, for example, a chat UI or the like.

In the example shown in FIG. 2, the passenger user interface 122-1 is provided in the vehicle 12 for the passenger PA1 of the vehicle 12, and the passenger user interface 122-2 is provided in the vehicle 12 for the passenger PA2 of the vehicle 12. The passenger user interfaces 122 (122-1, 122-2) interact with the passengers PA1, PA2 of the vehicle 12 when the passengers PA1, PA2 are boarding the vehicle 12.

In another example, as the passenger user interfaces 122 (122-1, 122-2), terminals (for example, smartphones) carried by the passengers PA1, PA2 of the vehicle 12 may be used. In this example, the passenger user interfaces 122 (122-1, 122-2) can interact with the passengers PA1, PA2 not only when the passengers PA1, PA2 of the vehicle 12 are boarding the vehicle 12, but also when the passengers PA1, PA2 of the vehicle 12 are not boarding the vehicle 12 (for example, after exiting the vehicle 12).

In the example shown in FIG. 1 and FIG. 2, the vehicle sensor 123 includes, for example, a clock, a vehicle position sensor for detecting the position of the vehicle 12 using, for example, a GPS (Global Positioning System) signal, a steering angle sensor for detecting the steering angle of the vehicle 12, a vehicle speed sensor, an acceleration sensor for detecting acceleration and deceleration of the vehicle 12, a jerk sensor, a gyro sensor, a thermometer, a hygrometer, etc.

The passenger experience optimization device 124 is configured by a microcomputer including a communication interface (I/F) 41, a memory 42, and a processor 43. The communication interface 41 includes an interface circuit for connecting the passenger experience optimization device 124 to the driver user interface 121, the passenger user interface 122, the vehicle sensor 123, the server device 11 outside the vehicle 12, etc. The memory 42 stores a program used in a process executed by the processor 43 and various data. The processor 43 has a function as an experience prediction unit 431, a function as an input information generation unit 432, a function as a feedback generation unit 433, and a function as a model reception unit 434.

The experience prediction unit 431 predicts the experience to be provided to the passengers PA1, PA2 of the vehicle 12 by the driver DR of the vehicle 12.

Specifically, in the example shown in FIG. 2, the experience prediction unit 431 uses a second machine learning model for the passenger PA1 of the vehicle 12 (namely, second machine learning model personalized for the passenger PA1 of the vehicle 12) to predict the experience of the passenger PA1 of the vehicle 12 based on input information input to the experience prediction unit 431 (second machine learning model for the passenger PA1 of the vehicle 12). The experience prediction unit 431 uses the second machine learning model for the passenger PA2 of the vehicle 12 to predict the experience of the passenger PA2 of the vehicle 12 based on the input information input to the experience prediction unit 431 (second machine learning model for the passenger PA2 of the vehicle 12).

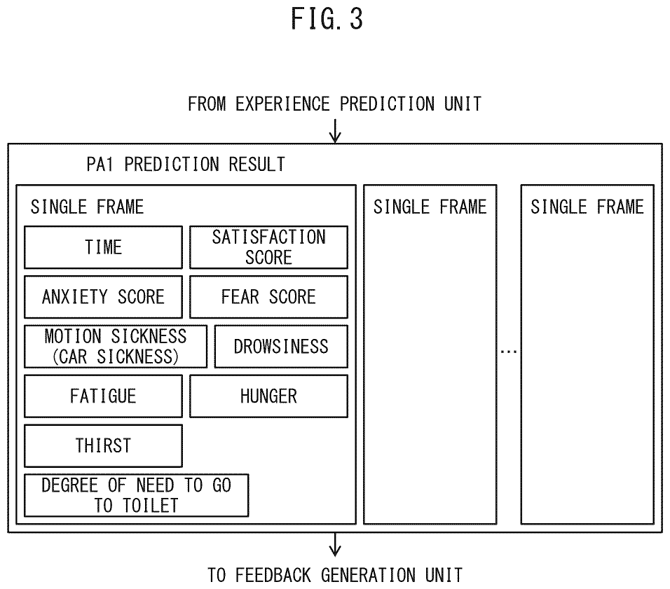

FIG. 3 is a view showing an example of the data structure of the experience of the passenger PA1 of the vehicle 12 predicted by the experience prediction unit 431 (prediction result of the experience of the passenger PA1 of the vehicle 12 output from the experience prediction unit 431).

In the example shown in FIG. 3, the data regarding the experience of the passenger PA1 of the vehicle 12 predicted by the experience prediction unit 431 (prediction result of the experience of the passenger PA1 of the vehicle 12 output from the experience prediction unit 431) includes a plurality of frames. Each frame includes the time measured by a clock serving as the vehicle sensor 123, a satisfaction score indicating the satisfaction of the passenger PA1 of the vehicle 12, an anxiety score indicating the degree of anxiety felt by passenger PA1 of the vehicle 12, a fear score indicating the degree of fear felt by passenger PA1 of the vehicle 12, information indicating motion sickness (vehicle sickness) of the passenger PA1 of the vehicle 12, information indicating the drowsiness of the passenger PA1 of the vehicle 12, information indicating the fatigue of the passenger PA1 of the vehicle 12, information indicating the hunger of the passenger PA1 of the vehicle 12, information indicating the thirst of the passenger PA1 of the vehicle 12, the degree to which passenger PA1 of the vehicle 12 wishes to use the toilet, etc.

In another example, the prediction result of the experience of the passenger PA1 of the vehicle 12 output from experience prediction unit 431 may be different from the example shown in FIG. 3, or the data structure of the prediction result may be different from the example shown in FIG. 3.

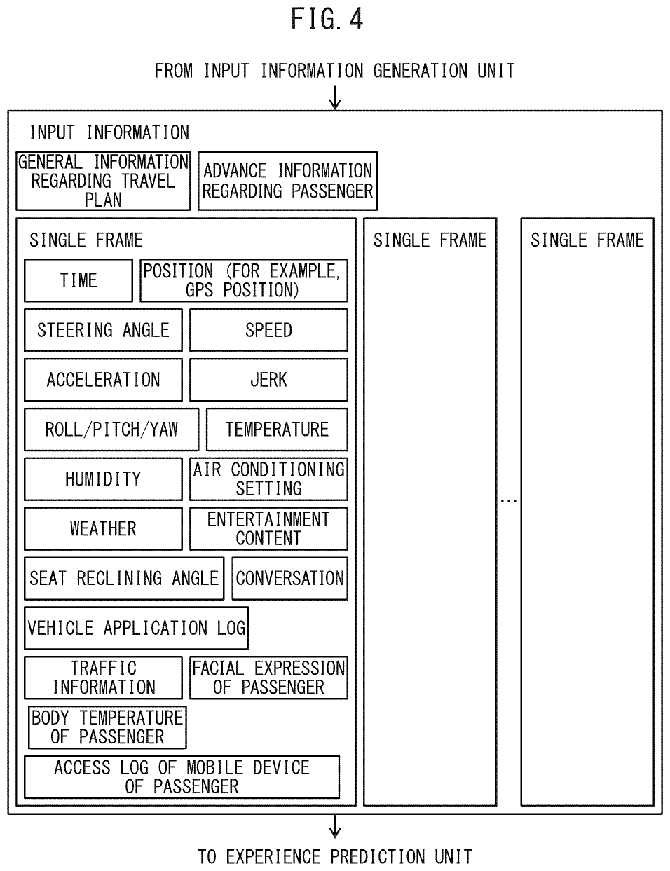

In the example shown in FIG. 1 and FIG. 2, the input information generation unit 432 generates input information (for example, input information shown in FIG. 4) to be input to the second machine learning model used by the experience prediction unit 431 based on the detection result of the vehicle sensor 123.

Specifically, in the example shown in FIG. 2, the input information generation unit 432 generates the input information to be input to the experience prediction unit 431 (second machine learning model for the passenger PA1 of the vehicle 12) based on the detection result of the vehicle sensor 123 for the second machine learning model for the passenger PA1 of the vehicle 12 to predict the experience of the passenger PA1 of the vehicle 12. Furthermore, the input information generation unit 432 generates the input information to be input to the experience prediction unit 431 (second machine learning model for the passenger PA2 of the vehicle 12) based on the detection result of the vehicle sensor 123 for the second machine learning model for the passenger PA2 of the vehicle 12 to predict the experience of the passenger PA2 of the vehicle 12.

FIG. 4 is a view showing an example of the data structure of the input information generated by the input information generation unit 432 and input to the experience prediction unit 431 (second machine learning model for the passenger PA1 of the vehicle 12).

In the example shown in FIG. 4, the input information generated by the input information generation unit 432 and input to the experience prediction unit 431 (second machine learning model for the passenger PA1 of the vehicle 12) includes general information regarding the travel plan, advance information regarding the passenger PA1 of the vehicle 12, the plurality of frames, etc. Each frame includes information indicating the time measured by the clock serving as the vehicle sensor 123, the position of the vehicle 12 detected by the vehicle position sensor serving as the vehicle sensor 123, the steering angle of the vehicle 12 detected by the steering angle sensor serving as the vehicle sensor 123, the speed of the vehicle 12 detected by the vehicle speed sensor serving as the vehicle sensor 123, the acceleration (deceleration) of the vehicle 12 detected by the acceleration sensor serving as the vehicle sensor 123, the jerk of the vehicle 12 detected by the jerk sensor serving as the vehicle sensor 123, the roll/pitch/yaw of the vehicle 12 detected by the gyro sensor serving as the vehicle sensor 123, the temperature of the interior of the vehicle 12, etc., detected by the thermometer serving as the vehicle sensor 123, and the humidity of the interior of the vehicle 12, etc., detected by the hygrometer serving as the vehicle sensor 123. Each frame also includes information indicating the air conditioning setting (not shown) of the vehicle 12, the weather, entertainment content such as television programs, music, radio, etc., being played inside the vehicle 12, the reclining angle of the seat (not shown) of the vehicle 12, conversation of the passenger PA1, etc., inside the vehicle 12, application log of the vehicle 12, traffic information generated outside the vehicle 12 and provided to the vehicle 12, facial expression of the passenger PA1, etc., of the vehicle 12 detected by a driver monitoring system (not shown), body temperature of the passenger PA1, etc., of the vehicle 12 detected by a temperature sensor (not shown) or the like, access log of a mobile device carried by passenger PA1, etc., of the vehicle 12, etc.

In another example, the input information generated by the input information generation unit 432 and input to the experience prediction unit 431 (second machine learning model for the passenger PA1 of the vehicle 12) may be different from the example shown in FIG. 4, or the data structure of the input information may be different from the example shown in FIG. 4.

In the example shown in FIG. 1 and FIG. 2, the feedback generation unit 433 generates feedback in natural language (for example, that it is necessary to select a driving course having few curves) to be provided to the driver DR of the vehicle 12 via the driver user interface 121 to improve the experience of the passengers PA1, PA2 of the vehicle 12 based on the experience of the passenger PA1 of the vehicle 12 (for example, the experience of the passenger PA1 regarding motion sickness) predicted by the experience prediction unit 431 (second machine learning model for the passenger PA1 of the vehicle 12), the experience of the passenger PA2 of the vehicle 12 (for example, the experience of the passenger PA2 regarding motion sickness) predicted by the experience prediction unit 431 (second machine learning model for the passenger PA2 of the vehicle 12), and information regarding the driver DR of the vehicle 12 received by the driver user interface 121 (for example, information indicating that the driver DR of the vehicle 12 drives carefully on a daily basis, etc.).

In another example (an example in which the vehicle 12 does not include the driver user interface 121), the feedback generation unit 433 may generate the feedback in natural language (for example, the need to suppress sudden acceleration and deceleration of the vehicle 12) to be provided to the driver DR of the vehicle 12 via the driver user interface 121 in order to improve the experience of the passengers PA1, PA2 of the vehicle 12 based on the experience of the passenger PA1 of the vehicle 12 (for example, the experience of the passenger PA1 regarding motion sickness) predicted by the experience prediction unit 431 (second machine learning model for the passenger PA1 of the vehicle 12) and the experience of the passenger PA2 of the vehicle 12 (for example, the experience of the passenger PA2 experience regarding motion sickness) predicted by the experience prediction unit 431 (second machine learning model for the passenger PA2 of the vehicle 12).

In the example shown in FIG. 1 and FIG. 2, the model reception unit 434 receives the second machine learning model for the passenger PA1 of the vehicle 12 and the second machine learning model for the passenger PA2 of the vehicle 12 used by the experience prediction unit 431 from the server device 11.

The server device 11 is configured by a microcomputer including a communication interface 111, a memory 112, and a processor 113. The communication interface 111 includes an interface circuit for connecting the server device 11 to the vehicle 12 or the like. The memory 112 stores a program used in a process executed by the processor 113 and various data. The processor 113 has a function as a passenger information generation unit 3A, a function as a model generation unit 3B, a function as a model transmission unit 3C, and a function as a driver identification unit 3D.

The passenger information generation unit 3A uses the first machine learning model to generate the information regarding the passenger PA1 of the vehicle 12 based on the result of the interaction between the passenger user interface 122-1 and the passenger PA1 of the vehicle 12. The passenger information generation unit 3A also uses the first machine learning model to generate the information regarding the passenger PA2 of the vehicle 12 based on the result of the interaction between the passenger user interface 122-2 and the passenger PA2 of the vehicle 12.

The information regarding the passengers PA1, PA2 of the vehicle 12 includes, for example, a personal identifier (for example, a user ID), the feedback history (log) of the passenger during past driving, age, height/weight, gender, health information, personality, physical characteristics, and vehicle experience preferences.

In the example shown in FIG. 1 and FIG. 2, the model generation unit 3B generates the second machine learning model for the passenger PA1 of the vehicle 12 to be used by the experience prediction unit 431 based on the information regarding the passenger PA1 of the vehicle 12. The model generation unit 3B also generates the second machine learning model for the passenger PA2 of the vehicle 12 to be used by the experience prediction unit 431 based on the information regarding the passenger of the passenger PA2 of the vehicle 12.

In another example, the model generation unit 3B may generate the second machine learning model for the passenger PA1 of the vehicle 12 to be used by the experience prediction unit 431 based on the information of the passenger PA1 of the vehicle 12 (for example, information indicating that passenger PA1 is experiencing motion sickness) and the detection result of the vehicle sensor 123 (for example, the detection result of a large value of acceleration) after the passenger PA1 boards the vehicle 12 and before interaction between the passenger user interface 122-1 and the passenger PA1 of the vehicle 12. In this example, the model generation unit 3B generates the second machine learning model for the passenger PA2 of the vehicle 12 to be used by the experience prediction unit 431 based on the information of the passenger PA2 of the vehicle 12 and the detection result of the vehicle sensor 123 after the passenger PA2 boards the vehicle 12 and before interaction between the passenger user interface 122-2 and the passenger PA2 of the vehicle 12.

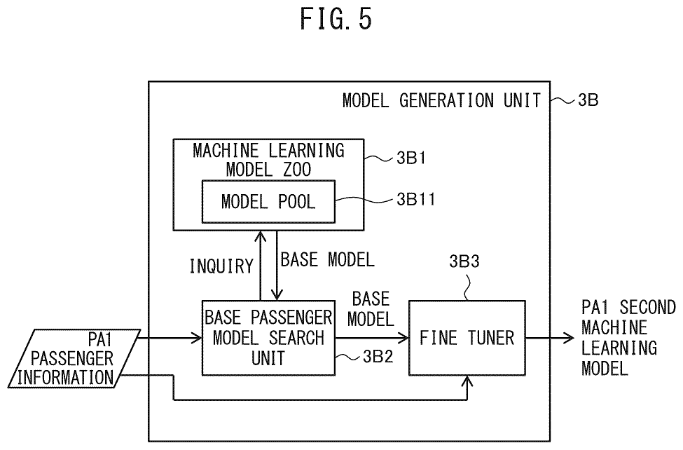

FIG. 5 is a view showing an example of a detailed configuration of the model generation unit 3B shown in FIG. 1 and FIG. 2.

In the example shown in FIG. 5, the model generation unit 3B includes a machine learning model zoo 3B1, a base passenger model search unit 3B2, and a fine tuner 3B3. The machine learning model zoo 3B 1 includes a model pool 3B 11, which is a pool having a plurality of base passenger models (a plurality of pre-trained machine learning models corresponding to various types of passengers). The base passenger model search unit 3B2 searches for a base passenger model which matches the passenger PA1 of the vehicle 12 from the model pool 3B 11 based on the information regarding the passenger PA1 of the vehicle 12. The fine tuner 3B3 generates the second machine learning model for the passenger PA1 of the vehicle 12 using the base passenger model searched by the base passenger model search unit 3B2. In detail, the fine tuner 3B3 generates the second machine learning model for the passenger PA1 of the vehicle 12 by executing fine-tuning of the base passenger model based on the information regarding the passenger PA1 of the vehicle 12.

When the passenger information regarding the passenger PA2 of the vehicle 12 is input to the model generation unit 3B, the model generation unit 3B generates the second machine learning model for the passenger PA2 of the vehicle 12.

In the example shown in FIG. 1 and FIG. 2, the model transmission unit 3C transmits the second machine learning model for the passenger PA1 of the vehicle 12 and the second machine learning model for the passenger PA2 of the vehicle 12 generated by the model generation unit 3B to the vehicle 12.

The driver identification unit 3D uses the first machine learning model to identify, for example, the driving skill, tendencies, characteristics, etc., of the driver DR of the vehicle 12 based on the information regarding the driver DR of the vehicle 12 received by the driver user interface 121 of the vehicle 12.

The experience prediction unit 431 of the vehicle 12 uses the second machine learning model for the passenger PA1 of the vehicle 12 generated by the model generation unit 3B of server device 11 and transmitted to the vehicle 12 by the model transmission unit 3C of server device 11 to predict the experience of the passenger PA1 of the vehicle 12 based on the input information input to the experience prediction unit 431 of the vehicle 12 (second machine learning model for the passenger PA1 of the vehicle 12).

In the example shown in FIG. 2, the two passengers PA1, PA2 board the vehicle 12, but in other examples, any number of passengers other than two may board the vehicle 12.

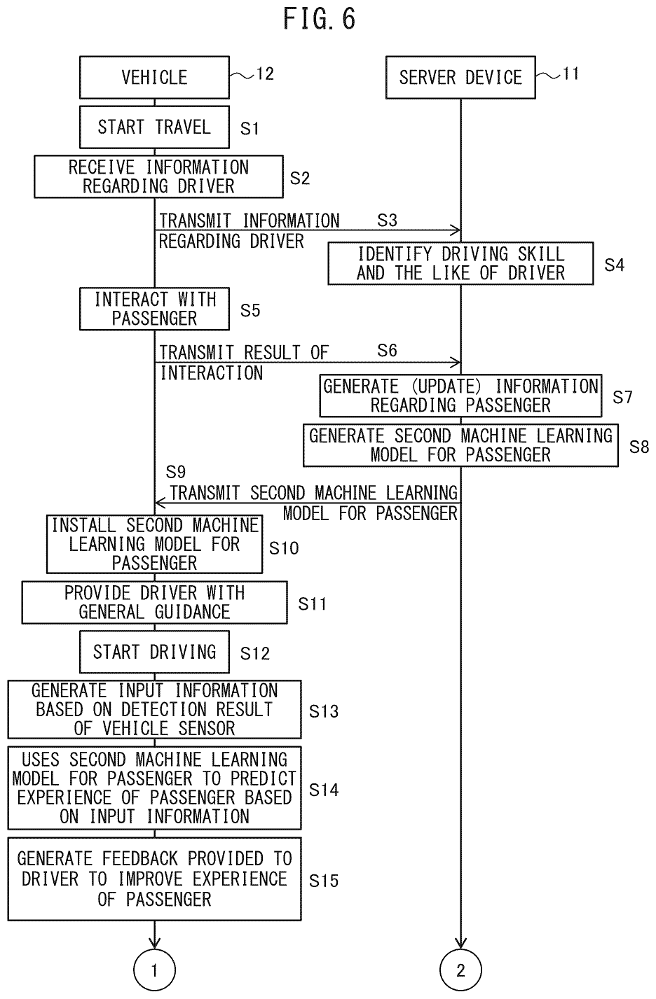

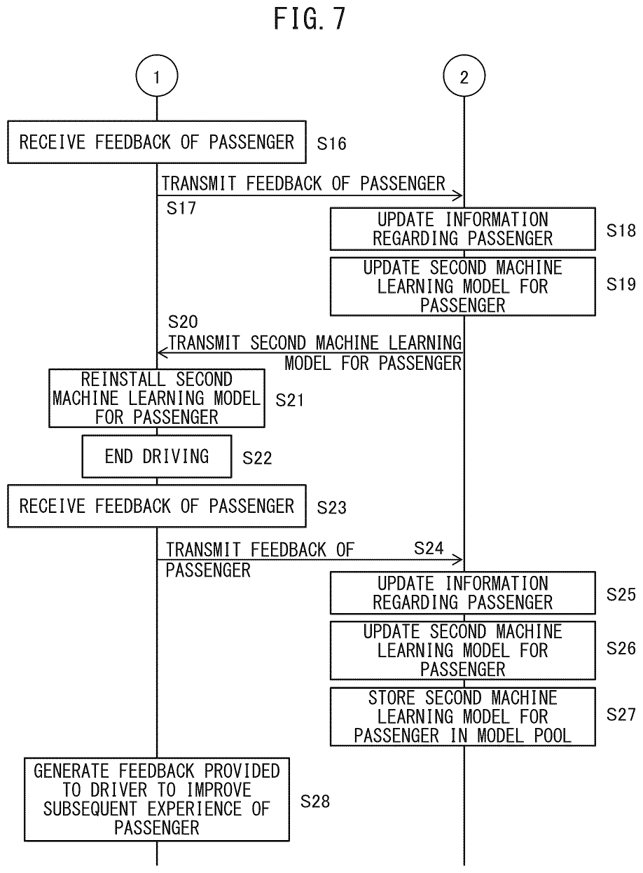

FIG. 6 and FIG. 7 are sequence diagrams for explaining an example of the process executed by the passenger experience optimization system 1 of the first embodiment.

In the example shown in FIG. 6 and FIG. 7, at step S1, the travel of the passenger PA1 using the vehicle 12 starts. Specifically, at step S1, the passenger experience optimization system 1 starts the process for optimizing the experience of the passenger PA1.

At step S2, the driver user interface 121 receives the information regarding the driver DR of the vehicle 12 from the driver DR of the vehicle 12.

At step S3, for example, the feedback generation unit 433 transmits the information regarding the driver DR of the vehicle 12 received by the driver user interface 121 at step S2 to the server device 11.

At step S4, the driver identification unit 3D uses the first machine learning model to identify, for example, the driving skill, tendencies, characteristics, etc., of the driver DR of the vehicle 12 based on the information regarding the driver DR of the vehicle 12 transmitted at step S3. Furthermore, the driver identification unit 3D stores the information regarding the driver DR of the vehicle 12 in, for example, the memory 112 or the like of the server device 11.

At step S5, the passenger user interface 122 (122-1) interacts with the passenger PA1 of the vehicle 12 using the first machine learning model.

At step S6, for example, the passenger user interface 122 (122-1) transmits the result of the interaction with the passenger PA1 of the vehicle 12 to the server device 11.

At step S7, the passenger information generation unit 3A uses the first machine learning model to generate the information regarding the passenger PA1 of the vehicle 12 based on the result of the interaction between the passenger user interface 122 (122-1) and the passenger PA1 of the vehicle 12 (update the information regarding the passenger PA1 of the vehicle 12 when the previous information exists).

At step S8, the model generation unit 3B generates the second machine learning model for the passenger PA1 of the vehicle 12 to be used at step S14 based on the information regarding the passenger PA1 of the vehicle 12 generated at step S7.

At step S9, the model transmission unit 3C transmits the second machine learning model for the passenger PA1 of the vehicle 12 generated at step S8 to the vehicle 12, and the model reception unit 434 receives the second machine learning model for the passenger PA1 of the vehicle 12.

At step S10, the experience prediction unit 431 installs the second machine learning model for the passenger PA1 of the vehicle 12.

At step S11, for example, the feedback generation unit 433 uses the first machine learning model to provide the driver DR of the vehicle 12 with general guidance necessary for the driver DR of the vehicle 12 to take care of the passenger PA1 of the vehicle 12 via the driver user interface 121.

At step S12, the driver DR of the vehicle 12 starts the driving of the vehicle 12 via the driver user interface 121. Specifically, the driver DR of the vehicle 12 performs an input operation for starting driving the vehicle 12 on the driver user interface 121 (for example, the steering wheel, the accelerator pedal, the brake pedal, etc.).

At step S13, the vehicle sensor 123 detects the time, the position of the vehicle 12, the steering angle of the vehicle 12, the speed of the vehicle 12, the acceleration (deceleration) of the vehicle 12, the jerk of the vehicle 12, the roll/pitch/yaw of the vehicle 12, the temperature inside the vehicle 12, the humidity inside the vehicle 12, etc., and inputs the detection results (sensor data) to the input information generation unit 432. Furthermore, the input information generation unit 432 generates the input information to be input to the second machine learning model used at step S14 based on the detection results of the vehicle sensor 123.

At step S14, the experience prediction unit 431 uses the second machine learning model for the passenger PA1 of the vehicle 12 to predict the experience of the passenger PA1 of the vehicle 12 based on the input information generated at step S13.

At step S15, the feedback generation unit 433 generates the feedback in natural language to improve the experience of the passenger PA1 of the vehicle 12 based on the experience of the passenger PA1 of the vehicle 12 predicted at step S14 and the information regarding the driver DR of the vehicle 12 received by the driver user interface 121 at step S2. The driver user interface 121 provides the feedback in natural language generated by the feedback generation unit 433 to the driver DR of the vehicle 12 by, for example, voice output, display on the speedometer, display on a navigation system, etc.

Specifically, step S13 to step S15 described above are repeatedly executed until the driving of the vehicle 12 is completed (i.e., until step S22 is executed).

At step S16, the passenger user interface 122 (122-1) receives the feedback from the passenger PA1 of the vehicle 12.

At step S17, for example, the passenger user interface 122 (122-1) transmits the feedback of the passenger PA1 of the vehicle 12 to the server device 11.

At step S18, the passenger information generation unit 3A uses the first machine learning model to update the information regarding the passenger PA1 of the vehicle 12 based on the feedback of the passenger PA1 of the vehicle 12.

At step S19, the model generation unit 3B updates the second machine learning model for the passenger PA1 of the vehicle 12 based on the information regarding the passenger PA1 of the vehicle 12 updated at step S18.

At step S20, the model transmission unit 3C transmits the second machine learning model for the passenger PA1 of the vehicle 12 updated at step S19 to the vehicle 12, and the model reception unit 434 receives the second machine learning model for the passenger PA1 of the vehicle 12.

At step S21, the experience prediction unit 431 reinstalls the second machine learning model for the passenger PA1 of the vehicle 12 that was updated at step S19.

Specifically, step S16 to step S21 described above are repeatedly executed until the driving of the vehicle 12 is completed (i.e., until step S22 is executed).

At step S22, the driver DR of the vehicle 12 ends the driving of the vehicle 12 via the driver user interface 121.

At step S23, the passenger user interface 122 (122-1) receives overall feedback of the passenger PA1 of the vehicle 12 (more specifically, summary of the feedback of the passenger PA1 of the vehicle 12 while the vehicle 12 is being driven).

At step S24, for example, the passenger user interface 122 (122-1) transmits the overall feedback of the passenger PA1 of the vehicle 12 to the server device 11.

At step S25, the passenger information generation unit 3A uses the first machine learning model to update the information regarding the passenger PA1 of the vehicle 12 based on the overall feedback of the passenger PA1 of the vehicle 12.

At step S26, the model generation unit 3B updates the second machine learning model for the passenger PA1 of the vehicle 12 based on the information regarding the passenger PA1 of the vehicle 12 updated at step S25.

At step S27, the model generation unit 3B stores the second machine learning model for the passenger PA1 of the vehicle 12 updated at step S26 in the model pool 3B 11.

At step S28, the feedback generation unit 433 generates the feedback in natural language to improve a subsequent experience of the passenger PA1 of the vehicle 12 based on the overall feedback of the passenger PA1 of the vehicle 12 received by the passenger user interface 122 (122-1) at step S23. Furthermore, the driver user interface 121 provides the feedback in natural language generated by the feedback generation unit 433 to the driver DR of the vehicle 12.

The best experience for the passenger PA1 of the vehicle 12 may not be the best experience for the passenger PA2 of the vehicle 12. Specifically, due to differences in the personal characteristics of the passenger PA1 of the vehicle 12 and the passenger PA2 of the vehicle 12, the sensations of the passenger PA1 of the vehicle 12 may differ from the sensations of the passenger PA2 of the vehicle 12.

As described above, in the passenger experience optimization system 1 of the first embodiment, the experience prediction unit 431 predicts the experience of the passenger PA1 of the vehicle 12 using the second machine learning model for the passenger PA1 of the vehicle 12, and predicts the experience of the passenger PA2 of the vehicle 12 using the second machine learning model for the passenger PA2 of the vehicle 12, and the feedback generation unit 433 generates the feedback in natural language to be provided to the driver DR of the vehicle 12 to improve the experiences of the passengers PA1, PA2 of the vehicle 12 based on the experience of the passenger PA1 of the vehicle 12 and the experience of the passenger PA2 of the vehicle 12 predicted by the experience prediction unit 431.

Thus, in the passenger experience optimization system 1 of the first embodiment, even in such a case, the driver DR of the vehicle 12 can provide the passengers PA1, PA2 with a suitable experience.

There may be cases where the circumstances in which passenger PA1 of the vehicle 12 is likely to suffer from motion sickness are different from the circumstances in which passenger PA2 of the vehicle 12 is likely to suffer from motion sickness, or where passenger PA2 of the vehicle 12 does not suffer from motion sickness in a situation in which passenger PA1 of the vehicle 12 suffers from motion sickness.

In such cases, in the passenger experience optimization system 1 of the first embodiment, the driver DR of the vehicle 12 can provide a level of experience that both the passenger PA1 and the passenger PA2 feel is suitable (though not the level that which is felt as optimal).

If the passengers PA1, PA2 of the vehicle 12 give direct feedback, such as verbally, to the driver DR of the vehicle 12, the driver DR of the vehicle 12 may feel that their driving skill is being denied. The passengers PA1, PA2 of the vehicle 12 may be reluctant to give direct feedback, such as verbally, to the driver DR of the vehicle 12. Thus, it is considered difficult for the passengers PA1, PA2 of the vehicle 12 to give direct feedback, such as verbally, to the driver DR of the vehicle 12.

As described above, in the passenger experience optimization system 1 of the first embodiment, the passenger user interface 122 (122-1, 122-2) interacts with the passengers PA1, PA2 of the vehicle 12 using the first machine learning model, the information regarding the passengers PA1, PA2 of the vehicle 12 is generated based on the results of the interaction, and the second machine learning models for the passengers PA1, PA2 of the vehicle 12 used by the experience prediction unit 431 are generated based on the information regarding the passengers PA1, PA2 of the vehicle 12.

Thus, in the passenger experience optimization system 1 of the first embodiment, the driver DR of the vehicle 12 can provide the passengers PA1, PA2 with a suitable experience without the need for the passengers PA1, PA2 of the vehicle 12 to provide direct feedback to the driver DR of the vehicle 12.

For example, even if the passenger PA1 of the vehicle 12 feels that the ride of the vehicle 12 is uncomfortable, if the passenger PA1 of the vehicle 12 is not aware of the reason why they feel that the ride of the vehicle 12 is uncomfortable, the passenger PA1 of the vehicle 12 cannot provide direct feedback to the driver DR of the vehicle 12.

In the passenger experience optimization system 1 of the first embodiment, even in such a case, the driver DR of the vehicle 12 can provide the passenger PA1 with a suitable experience.

For example, there may be a case in which the passenger PA1 of the vehicle 12 is too young to provide direct feedback to the driver DR of the vehicle 12.

In the passenger experience optimization system 1 of the first embodiment, even in such a case, the driver DR of the vehicle 12 can provide the passenger PA1 with a suitable experience.

Since appropriate feedback to the driver DR of the vehicle 12 differs depending on the (personality of the) driver DR of the vehicle 12, it is considered difficult for the passengers PA1, PA2 of the vehicle 12 to directly provide appropriate feedback to the driver DR of the vehicle 12.

As described above, in the passenger experience optimization system 1 of the first embodiment, the driver DR of the vehicle 12 can provide the passengers PA1, PA2 with a suitable experience without need for the passengers PA1, PA2 of the vehicle 12 to provide direct feedback to the driver DR of the vehicle 12.

As described above, in the passenger experience optimization system 1 of the first embodiment, the experience prediction unit 431 predicts the experiences of the passengers PA1, PA2 of the vehicle 12 using the second machine learning models for the passengers PA1, PA2 of the vehicle 12, and the feedback generation unit 433 generates the feedback in natural language to be provided to the driver DR of the vehicle 12 based on the experiences of the passengers PA1, PA2 of the vehicle 12 predicted by the experience prediction unit 431.

Thus, in the passenger experience optimization system 1 of the first embodiment, the feedback to the driver DR of the vehicle 12 can be realized without compromising the relationship between the passengers PA1, PA2 of the vehicle 12 and the driver DR of the vehicle 12.

As described above, in the passenger experience optimization system 1 of the first embodiment, the experience prediction unit 431 predicts the experience of the passenger PA1 of the vehicle 12 using the second machine learning model for the passenger PA1 of the vehicle 12, and predicts the experience of the passenger PA2 of the vehicle 12 using the second machine learning model for the passenger PA2 of the vehicle 12. Thus, the feedback generation unit 433 can appropriately generate the feedback to be provided to the driver DR of the vehicle 12 to improve the experience of the passenger PA1 of the vehicle 12 based on the experience of the passenger PA1 of the vehicle 12 predicted by the experience prediction unit 431, and can appropriately generate the feedback to be provided to the driver DR of the vehicle 12 to improve the experience of the passenger PA2 of the vehicle 12 based on the experience of the passenger PA2 of the vehicle 12 predicted by the experience prediction unit 431. Specifically, the feedback generation unit 433 can generate the feedback to be provided to the driver DR of the vehicle 12 by reflecting the personalities, physical characteristics, preferences, tendencies, etc., of the passengers PA1, PA2 of the vehicle 12.

As described above, in the passenger experience optimization system 1 of the first embodiment, the driver DR of the vehicle 12 does not interact with the passengers PA1, PA2 of the vehicle 12, but the passenger user interface 122 interacts with the passengers PA1, PA2 of the vehicle 12 using the first machine learning models.

Thus, in the passenger experience optimization system 1 of the first embodiment, the experience prediction unit 431 can accurately predict the experiences of the passengers PA1, PA2 of the vehicle 12 even in cases where, for example, the passengers PA1, PA2 of the vehicle 12 have low communication skills, the relationship between the passengers PA1, PA2 of the vehicle 12 and the driver DR of the vehicle 12 is not friendly, or the experiences of the passengers PA1, PA2 of the vehicle 12 are difficult to explain.

As described above, in the passenger experience optimization system 1 of the first embodiment, the driver user interface 121 receives the information regarding the driver DR of the vehicle 12 from the driver DR of the vehicle 12 using the first machine learning model. Furthermore, the driver identification unit 3D uses the first machine learning model to identify, for example, the driving skill, tendencies, characteristics, etc., of the driver DR of the vehicle 12 based on the information regarding the driver DR of the vehicle 12 received by the driver user interface 121 of the vehicle 12. Furthermore, the feedback generation unit 433 generates the feedback to be provided to the driver DR of the vehicle 12 to improve the experiences of the passengers PA1, PA2 of the vehicle 12 based on the information regarding the driver DR of the vehicle 12, etc.

Thus, in the passenger experience optimization system 1 of the first embodiment, appropriate feedback in accordance with the driving skill, tendencies, characteristics, etc., of the driver DR of the vehicle 12 can be provided to the driver DR of the vehicle 12.

In the passenger experience optimization system 1 of the first embodiment, since the driver user interface 121 can provide appropriate questions and messages to the driver DR of the vehicle 12 using the first machine learning model, the information regarding the driver DR of the vehicle 12 can effectively be obtained. Furthermore, since the passenger user interface 122 has the function of interacting with the passengers PA1, PA2 of the vehicle 12 using the first machine learning models (i.e., providing appropriate questions and messages to the passengers PA1, PA2 of the vehicle 12), the information regarding the passengers PA1, PA2 of the vehicle 12 can effectively be obtained.

As described above, in the passenger experience optimization system 1 of the first embodiment, the information regarding the driver DR of the vehicle 12 (including the experience of the driver DR of the vehicle 12) and the second machine learning models for the passengers PA1, PA2 of the vehicle 12 are stored in the server device 11. Thus, in the passenger experience optimization system 1 of the first embodiment, the previous experiences of the driver DR of the vehicle 12 stored in the server device 11 can be used to improve the current experience of the driver DR of the vehicle 12.

### Second Embodiment

The passenger experience optimization system 1 of a second embodiment is configured in same manner as the passenger experience optimization system 1 of the first embodiment described above, except for the points described below.

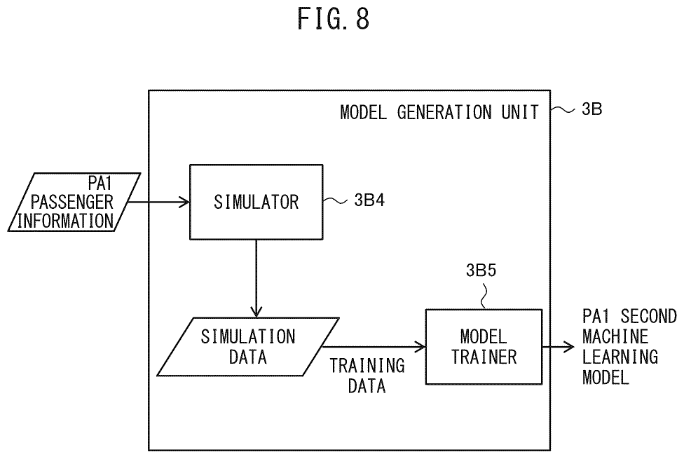

FIG. 8 is a view showing an example of a detailed configuration of the model generation unit 3B of the passenger experience optimization system 1 of the second embodiment.

In the example shown in FIG. 8, the model generation unit 3B includes a simulator 3B4 and a model trainer 3B5. The simulator 3B 4 executes a simulation of the experience of the passenger PA1 of the vehicle 12 under various conditions based on the information regarding the passenger PA1 of the vehicle 12. The “various conditions” include a plurality of positions of the vehicle 12 and a plurality of control parameters including steering, driving, and braking of the vehicle 12. Furthermore, the simulator 3B4 generates a training data set including a simulated experience obtained by executing the simulation and condition when the simulation was executed. The model trainer 3B5 trains the second machine learning model using the training data set generated by the simulator 3B4.

### Third Embodiment

The passenger experience optimization system 1 of a third embodiment is configured in the same manner as the passenger experience optimization system 1 of the first embodiment described above, except for the points described below.

In the passenger experience optimization system 1 of the first embodiment, step S16 to step S21 shown in FIG. 7 are executed as described above.

Conversely, in the passenger experience optimization system 1 of the third embodiment, step S16 to step S21 shown in FIG. 7 are not executed.

As described above, the embodiments of the passenger experience optimization system, the passenger experience optimization method, and the passenger experience optimization device of the present disclosure have been described with reference to the drawings. However, the passenger experience optimization system, the passenger experience optimization method, and the passenger experience optimization device of the present disclosure are not limited to the embodiments described above, and can be appropriately modified without departing from the spirit of the present disclosure. The configuration of each example of the embodiments described above may be appropriately combined. Though the process performed by the passenger experience optimization system 1 has been described as software process performed by executing the program in the embodiments described above, the process performed by the passenger experience optimization system 1 may be process performed by hardware. Alternatively, the process performed in the passenger experience optimization system 1 may be process which combines both software and hardware. Furthermore, the program stored in the memory 112 of the server device 11 of the passenger experience optimization system 1 (the program for realizing the functions of the processor 113 (server device processor) of the server device 11 of the passenger experience optimization system 1) and the program stored in the memory 42 of the passenger experience optimization device 124 (the program for realizing the functions of the processor 43 (vehicle processor) of the passenger experience optimization device 124) may be recorded and provided, distributed, etc., on a computer-readable storage medium such as a semiconductor memory, a magnetic recording medium, an optical recording medium, etc.

1. A passenger experience optimization system comprising a vehicle including a vehicle sensor and a vehicle processor and a server device including a server device processor, wherein
the vehicle includes a passenger user interface for interacting with at least one passenger of the vehicle using a first machine learning model,
the server device processor is configured to:
generate information regarding the at least one passenger based on a result of interaction with the at least one passenger, and
generate a second machine learning model for each passenger based on the information regarding the at least one passenger, and
the vehicle processor is configured to:
generate input information to be input to the second machine learning model for the second machine learning model to predict an experience of the at least one passenger based on a detection result of the vehicle sensor, and
generate feedback in natural language to be provided to a driver of the vehicle for improving the experience of the at least one passenger based on at least the experience of the at least one passenger predicted by the second machine learning model.

2. The passenger experience optimization system according to claim 1, wherein the vehicle includes a driver user interface for receiving information regarding the driver of the vehicle, and
the vehicle processor is configured to generate the feedback based on the experience of the at least one passenger and the information regarding the driver of the vehicle.

3. The passenger experience optimization system according to claim 1, wherein the server device processor is configured to generate the second machine learning model for each passenger based on the information regarding the at least one passenger and the detection result of the vehicle sensor after the at least one passenger boards the vehicle and before the interaction with the at least one passenger is performed.

4. The passenger experience optimization system according to claim 1, wherein the server device processor is configured to:
search for one or more base passenger models which match the at least one passenger from a model pool based on the information regarding the at least one passenger, and
generate the second machine learning model using the base passenger models, and
the model pool includes at least one pretrained machine learning model which corresponds to various types of passengers.

5. The passenger experience optimization system according to claim 4, wherein the server device processor is configured to generate the second machine learning model by executing fine-tuning of the base passenger models based on the information regarding the at least one passenger.

6. The passenger experience optimization system according to claim 1, wherein the server device processor is configured to:
execute a passenger experience simulation under various conditions based on the information regarding the at least one passenger,
generate a training data set including condition and simulated experience, and
train the second machine learning model using the training data set.

7. The passenger experience optimization system according to claim 6, wherein the various conditions include a plurality of positions of the vehicle and a plurality of control parameters including steering, driving, and braking of the vehicle.

8. A passenger experience optimization method comprising:
interacting with at least one passenger of a vehicle using a first machine learning model,
generating information regarding the at least one passenger based on a result of interaction with the at least one passenger,
generating a second machine learning model for each passenger based on the information regarding the at least one passenger,
generating input information to be input to the second machine learning model for the second machine learning model to predict an experience of the at least one passenger based on a detection result of a vehicle sensor, and
generating feedback in natural language to be provided to a driver of the vehicle for improving the experience of the at least one passenger based on at least the experience of the at least one passenger predicted by the second machine learning model.

9. A passenger experience optimization device provided in a vehicle including a vehicle sensor and a passenger user interface for interacting with at least one passenger of the vehicle using a first machine learning model, wherein
the passenger experience optimization device comprises a processor,
information regarding the at least one passenger is generated based on a result of interaction with the at least one passenger,
a second machine learning model is generated for each passenger based on the information regarding the at least one passenger, and
the processor is configured to:
generate input information to be input to the second machine learning model for the second machine learning model to predict an experience of the at least one passenger based on a detection result of the vehicle sensor, and
generate feedback in natural language to be provided to a driver of the vehicle for improving the experience of the at least one passenger based on at least the experience of the at least one passenger predicted by the second machine learning model.
